(19) United States
(12) Patent Application Publication
(10) Pub. No.: US 2016/0029030 A1
(43) Pub. Date: Jan. 28, 2016

(54) TRANSMITTING AND RECEIVING A COMPOSITE IMAGE

(71) Applicants: Marta MARK, London (GB); Matteo NACCARI, London (GB)

(72) Inventors: Marta Mrak, London (GB); Matteo Naccari, London (GB)

(21) Appl. No.: 14/782,404

(22) PCT Filed: Mar. 31, 2014
(86) PCT No.: PCT/GB2014/051010

§ 371 Date: Oct. 5, 2015

(30) Foreign Application Priority Data
Apr. 5, 2013 (GB) 1306209.6

(51) Int. Cl. H04N 19/21; H04N 19/91; H04N 19/176; H04N 19/503; H04N 19/593

(52) U.S. Cl. CPC H04N 19/21; H04N 19/503; H04N 19/593; H04N 19/176; H04N 19/91

(57) ABSTRACT

For a video sequence having at least one composite image comprising a foreground and a transparency mask, a video encoder transmits the encoded foreground image and the encoded transparency mask together with a flag signifying whether or not the encoded transparency mask is to be decoded as a binary transparency mask. Clipping values may be signalled to the decoder for use in clipping of a decoded binary transparency mask.

### FIELD OF THE INVENTION

This invention relates generally to transmitting and receiving a composite image and in the most important example to video broadcasting systems and notably to a framework which enables the transmission of additional information useful for post-production editing and/or composition of video sequences. With this framework, flexibility in content production can be achieved in the context of digital video broadcasting.

### BACKGROUND TO THE INVENTION

Embodiments of this invention are directed to the digital video broadcasting area which aims at delivering video content through the broadcasting chain which roughly consists in four phases: video content production, post-production editing, video content transmission and receiver reception with possible further processing. During the post-production editing and receiver side processing phases, a video is manipulated in order to enhance its quality, insert or delete some image areas, compose it with other videos, etc. Moreover, at the receiver side, some processing could be also performed to embed secondary streams which carry additional information for particular audience. An example of this additional information may be represented by the sign language interpreter video to help deaf people to follow broadcasted programs. The processing carried out during the aforementioned manipulations may require some information which needs to be shared among the different parties involved in the broadcasting delivery chain. Therefore, it is important to provide an efficient representation of this information to allow flexibility in the content manipulation and transmission at affordable bandwidth.

One example of such information needed for post-production and/or receiver side processing is a transparency mask represented by the so-called alpha channel. An alpha channel is a signal associated to a particular video content and is typically used to compose different videos together or to insert objects in a video. It should be noted however that the transparency mask of this invention may encompass an alpha channel of any form. In particular, an alpha channel may be represented as a video sequence with the same number of frames and whereby each frame has the same width and height of the frames relative to the video content associated to the alpha channel. Each pixel in alpha channel signals assumes a value in the range [vₘᵢₙ, vₘₐₓ] which represents the degree of opacity (or equivalently the degree of transparency) for that particular pixel. An example of one frame for a particular alpha channel is shown in FIG. 1. The white pixels correspond to the opaque pixels while the black to the transparent ones. The pixel in the video content whose associated alpha channel is transparent will not be displayed on the user screen while opaque pixels will be. As may be noted from FIG. 1, the frames of alpha channel signals can be compressed using state-of-the-art video compression techniques as spatial transformation, quantisation, motion compensation, intra prediction, etc.

### SUMMARY OF THE INVENTION

It is an objective of the present invention to enable the transmission of information useful for video editing and post production processing performed at different stages of one typical video broadcasting delivery chain.

In one aspect the present invention consists in a method of transmitting a composite image comprising at least a foreground image and a transparency mask, comprising the steps of encoding the foreground image; encoding the transparency mask as an image; and transmitting the encoded foreground image and the encoded transparency mask together with a flag signifying whether or not the encoded transparency mask is to be decoded as a binary transparency mask in which each pixel can take only two values. Pixel values may be compared in a transparency mask with a threshold to derive a binary transparency mask. Clipping values may be signalled to a decoder for use in clipping of a decoded binary transparency mask.

A binary transparency mask may be encoded by partitioning each mask into a non-overlapping grid of blocks; coding each block by transmitting its pixel value if all the pixels of the block share the same value or a split flag to signal that the block should be further split; and continuing the process recursively. A minimum allowed block size may be determined and the process of block splitting continues recursively until the minimum allowed block size is reached. Blocks with the minimum size which contain pixels with values which are not all equal may be encoded using predictive and entropy coding techniques.

Preferably, the method further comprises the steps of determining whether the transparency mask is the same as a transparency mask of a preceding image in the video sequence; encoding the transparency mask as an image only where the transparency mask is not the same as a transparency mask of a preceding image; and transmitting any encoded transparency mask together with a flag signifying whether the encoded transparency mask for a preceding image is to be used in association with the encoded foreground image of the current image.

Suitably, the method further comprises the step of transmitting the encoded foreground image together with compositing information such as the size or location of the foreground image in the composite image. The compositing information may include the colour of pixels forming a frame of the composite image.

In another aspect, the present invention consists in a method of decoding a composite image, comprising the steps of receiving an encoded foreground image and an encoded transparency mask together with a flag; decoding the encoded foreground image; where indicated by said flag, decoding the encoded transparency mask as a binary transparency mask in which each pixel can take only two values; and using the foreground image in association with the binary transparency mask in forming a composite image. The step of decoding the encoded transparency mask as a binary transparency mask may comprise a decoding step to produce a preliminary transparency mask in which pixels are not constrained to take only two values; and a clipping step to produce a binary transparency mask in which pixels are constrained to take only two values. The clipping step may utilise clipping values signalled to the decoder by an encoder.

An encoded binary transparency mask may be partitioned into blocks; the received value is read for each block and if it is equal to either of said two allowed values, then the pixels for the current block are set to the received value; otherwise, the current block is split into blocks with reduced size and the process repeated recursively. If the split process leads to blocks with size equal to the minimum allowed value, then the value of the pixel is set to a value obtained by adding the received difference 5 and the value of the previously decoded pixel.

Preferably, the method further comprises the step of receiving a flag; and where indicated by said flag, using the foreground image in association with the transparency mask for a preceding image in forming a composite image.

Suitably, the method further comprises the step of receiving an encoded foreground image together with compositing information; and using the foreground image in accordance with the compositing information to form a composite image. The foreground image may be scaled according to size information in the compositing information. The foreground image may be positioned in the composite image according to position information in the compositing information. A frame of the composite image may assume a colour specified by the compositing information.

The composite image may form part of a video sequence of images with coded data relating to the transparency mask is transmitted as a secondary picture in the same access unit as the coded data relating to the foreground image forming the primary coded picture. The foreground image and transparency mask may be encoded according to a video coding standard such as H.264/AVC and HEVC. Each flag may be represented in the syntax header element Sequence Parameter Set (SPS) of the H.264/AVC or HEVC standard.

Compositing information may be organised in a Supplementary Enhanced Information (SEI) message as specified by the H.264/AVC and the HEVC standards. The information contained in the SEI message for the purpose of frame composition may persist for only the time instant where the SEI message is received or may persist until a new SEI message is received.

In the following description, the term alpha channel will used to describe an example of a transparency mask.

According to one arrangement, a video sequence corresponding to the main broadcasted program is divided into frames which are encoded using motion compensated predictive video coding techniques standardised by H.264/AVC or the new High Efficiency Video Coding (HEVC) standard. Both for the H.264/AVC and HEVC standards, the coded data relative to one frame are organised into access units which contain a set of Network Abstraction Layer (NAL) units. Each NAL unit contains the coded data relative to the coded video sequence. These data may be headers relative to video sequence parameter (e.g. frame width and height) or may be data relative to the frame pixels themselves. In order to keep together the main broadcasted program and its associated alpha channel, the presence of alpha channel pictures (hereafter will be also denoted as secondary pictures) is signalled in the same access unit of the coded picture relative to the main video broadcasted video (hereafter also referred as the foreground image or primary picture). It may also be useful to signal data for frame composition, alpha channel processing after decoding and post processing the frame composed using the alpha channel. Finally, there is also provided a simplified coding algorithm for alpha channel signals which assume only two values (Vₜᵣₐₙₛₚₐᵣₑₙₜ and v_{opaque}) and are also denoted as binary alpha channels.

### BRIEF DESCRIPTION OF THE DRAWINGS

FIG. 1 shows an example of an alpha channel associated to one frame of the main video sequence.

FIG. 2 shows an example of frame composition from two main pictures (frame 0 and frame 1) with a frame background of one particular colour.

FIG. 3 shows an example of organisation of primary and secondary pictures in a bitstream according to the H.264/AVC and HEVC standards.

FIG. 4 shows an example of broadcasting application which uses a fixed alpha channel for all frames.

FIG. 5 shows an example of clipping for the alpha channel values.

FIG. 6 shows an example of binary clipping for the alpha channel values.

FIG. 7 shows an example of DPCM encoding of the values for a binary alpha channel.

### DETAILED DESCRIPTION OF THE PRESENT INVENTION

The present invention will now be described by a way of several examples related to the field of post-production editing and frame composition. These examples involve the use of secondary pictures to embed the alpha channel signal in video bitstreams to ease editing and processing. The examples also use the concept of Supplementary Enhanced Information (SEI) messages which are syntax elements carrying information useful for video processing. Finally, the examples also provide a simplified encoding algorithm for binary alpha channels which requires lower computational complexity with respect to classis and generic video coding techniques.

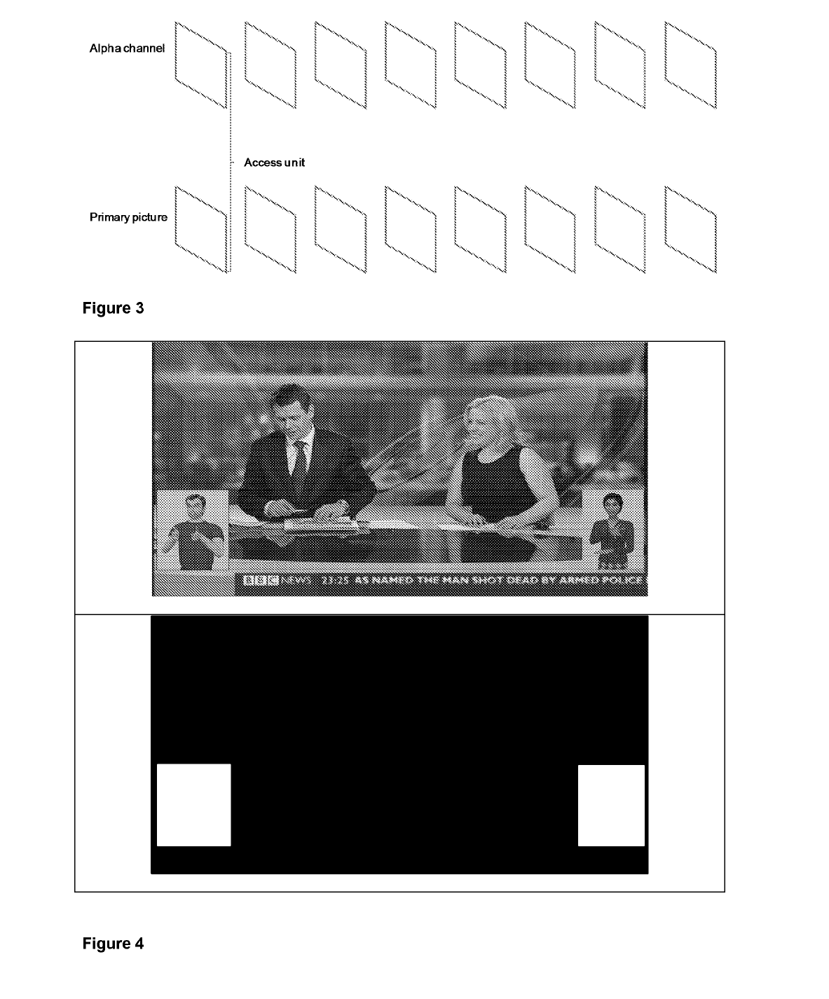

In order to keep together the data associated to the primary coded pictures and the alpha channel, it is proposed to signal the presence of the alpha channel compressed data in each access unit relative to the primary picture. FIG. 3 provides a schematic representation of this organisation whereas one access unit contains the alpha channel data for the primary coded picture. As explained in the “background to the invention” section, alpha channel signals can be compressed using the same encoding tools standardised by video coding standards as H.264/AVC and HEVC. Moreover, since the alpha channel specifies the degree of opacity for each pixel, it can be seen as a monochrome image (i.e. luma only picture). When the alpha channel is present, the transparent and opaque values need to be transmitted. Furthermore, it is needed to transmit whether the alpha channel is binary or not. Finally, also the bits per pixel in the alpha channel are transmitted as they may be different from the one of the main coded video. The aforementioned information can be sent in the syntax structures of the coded video which carry the sequence level parameters. In one example, the whole signalling framework can be placed in the Sequence Parameter Set (SPS) of the H.264/AVC and HEVC standard as follows:

...
seq_parameter_set {

secondary_pictures_present
if( secondary_picture_present != 0 ) {

is_binary_secondary_picture
if( is_binary_secondary_picture == 0 )

bit_depth_secondary_picture

value_opaque_pixels
value_transparent_pixel

}

}
...

The flag secondary_picture_present specifies whether in the same access unit of the primary picture, the coded data of the alpha channel are present. The flag is_binary_secondary_picture specifies whether the transparency mask is a binary picture and therefore can assume only two values (transparent and opaque). The quantity bit_depth_secondary_picture specifies the bit depth for the pixels in the alpha channel. In case of binary transparency mask, this quantity is equal to one. The quantity value_opaque_pixels specifies the value for pixels in the alpha channel which are classified as opaque and dually the quantity value_transparent_pixels specifies the value for transparent pixels.

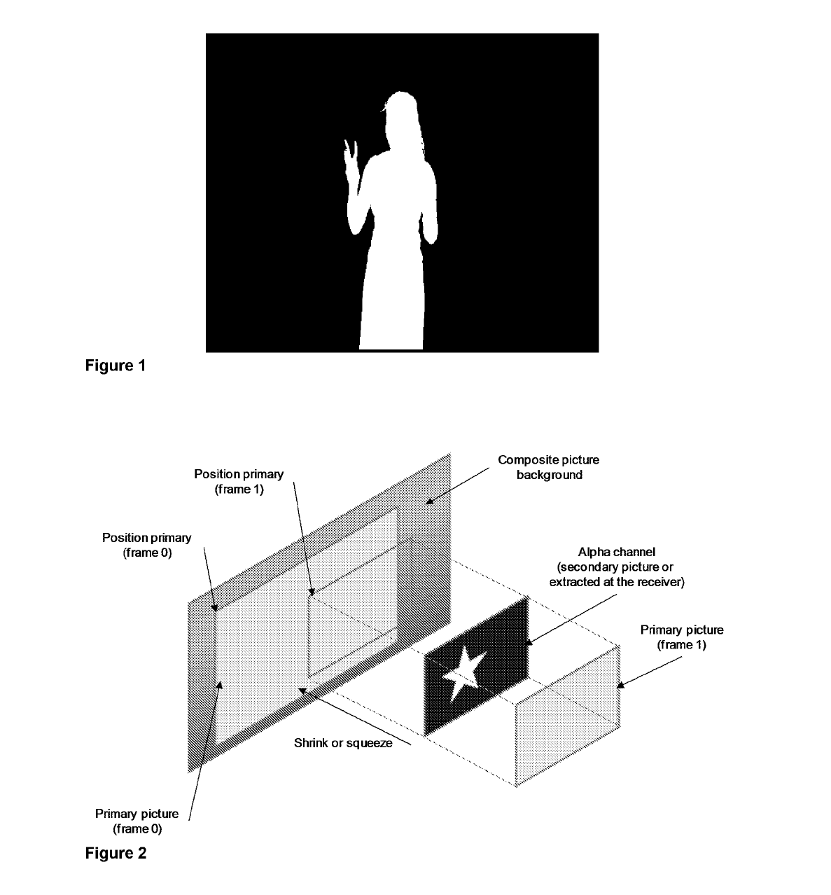

In some applications the required alpha channel may assume only binary values, i.e. either αₜᵣₐₙₛₚₐᵣₑₙₜ or α_{opaque}. Examples of some applications are logo insertion advertisements broadcasting or insertion of the sign language interpreters in the news to help deaf people to follow the programs. Since only a binary channel is required, the encoding process is simplified by having only two values to transmit. The use of a binary alpha channel is denoted by a flag. An example of binary alpha channel is depicted in FIG. 1. Binary alpha channels can be seen as masks to separate foreground from background objects.

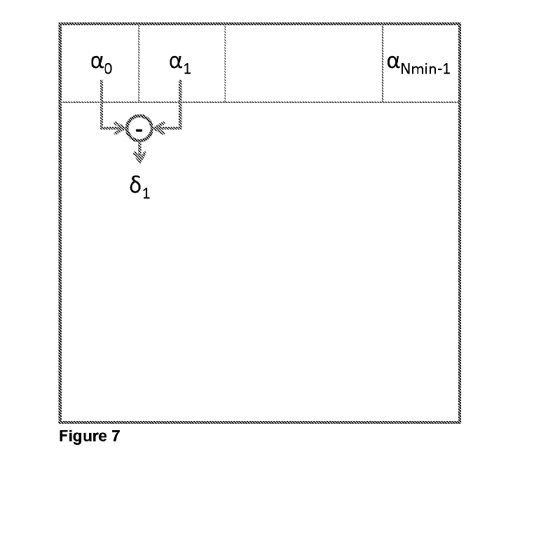

Given that the alpha channel may be used during the frame composition, the accurate coding of its sharp edges is important. In fact, conventional lossy compression algorithms may smooth and blur the edges of binary alpha channels resulting into annoying artifacts in the final composed frame. Moreover, from FIG. 1 it may be noted that alpha channel signal are characterised by large homogenous areas where all the pixels are all either transparent or opaque. In one form of this invention it is proposed to encode binary alpha channels by approximating them with square regions with size N×N where N assumes values in the range [Nmin, Nmax]. In particular, a given frame for the alpha channel is partitioned into a non-overlapping grid of Nmax×Nmax square blocks. For each square B, the value for each pixel inside is evaluated. If all the pixels belonging to B have value equal to either αₜᵣₐₙₛₚₐᵣₑₙₜ or α_{opaque} the value is transmitted and the coding algorithm moves to the next square block with dimensions Nmax×Nmax. Conversely, if not all the pixels assume values equal to either αₜᵣₐₙₛₚₐᵣₑₙₜ or α_{opaque} the block B is split into four blocks, each one with dimensions (Nmax/2)×(Nmax/2). Over each block obtained by this splitting, the pixels belonging to each block are evaluated again to check whether all assume values equal to either αₜᵣₐₙₛₚₐᵣₑₙₜ or α_{opaque}. The splitting operation continues until the block size reaches the minimum size of Nmin. If one block with size Nmin×Nmin contains values which are not all equal to either αₜᵣₐₙₛₚₐᵣₑₙₜ or α_{opaque}, then the values inside the block are encoded using a Differential Pulse Code Modulation (DPCM) technique. In particular, FIG. 7 describes the DPCM process whereas for each pixel value αᵢ the difference δᵢ between and is computed and transmitted. The transmission can use any entropy encoding technique proposed in the literature as Huffman coding, arithmetic coding, etc. The signal whether the block being considered needs to be split a conventional value (e.g. αₛₚₗᵢₜ) different from αₜᵣₐₙₛₚₐᵣₑₙₜ and α_{opaque} is transmitted. Therefore, the decoder starts the decoding by reading the transmitted value for the first square Nmax×Nmax block. If the received value is either αₜᵣₐₙₛₚₐᵣₑₙₜ or α_{opaque} then the decoder sets the value for all the pixels belonging to the current block to the received value and moves to the next Nmax×Nmax square block. Otherwise, the decoder splits the current block into four blocks of size (Nmax/2)×(Nmax/2) and reads the next received value. The splitting continues recursively until the block size reaches the minimum size allowed Nmin. In this case the values that the decoder will receive refer to the alpha channel values which have been encoded using DPCM.

When the transmitted alpha channel signal is decoded, its values may need to be clipped in order to stay in the range [αₜᵣₐₙₛₚₐᵣₑₙₜ, α_{opaque}]. Moreover, for some video broadcasting applications, although the needed alpha channel is binary, the transmitter may apply some processing to soften/smooth the alpha channel so that the its compression can be improved. At the received, the decoded alpha channel has to be put back to a binary one. In this case an appropriate threshold should be applied to the decoded alpha channel values. The needed thresholds can be signalled in the syntax structures of the coded video which carry the information for the sequence level parameters. In one example, threshold is signalled in the SPS as follows:

seq_parameter_set ( ) {

...
alpha_clipping_type
if( alpha_clipping_type == 1 )

alpha_clipping_binary

...

}

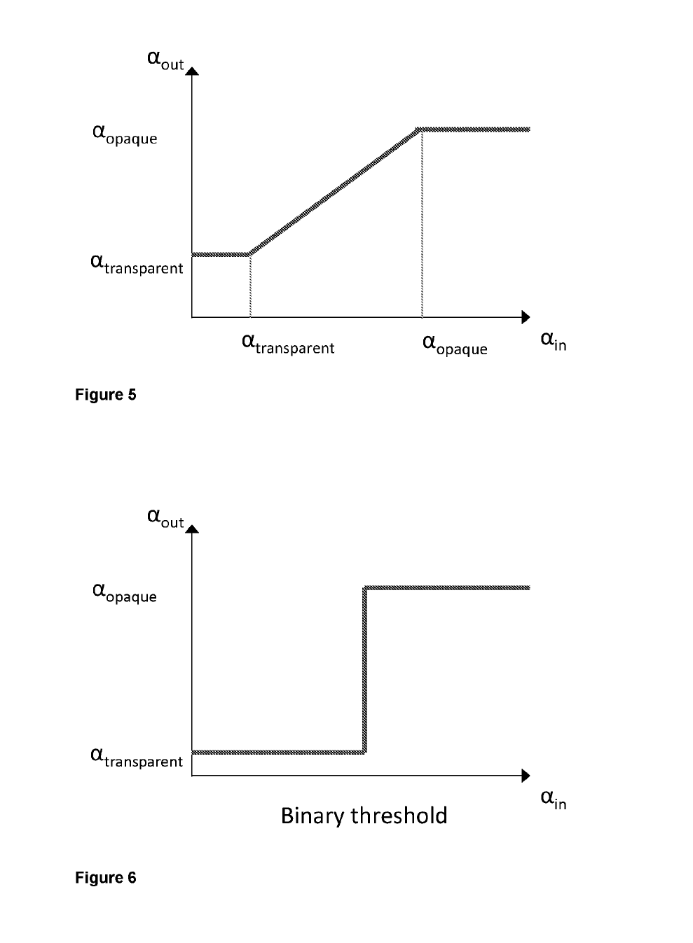

The quantity alpha_clipping_type specify which kind of clipping may be applied to the alpha channel values. Examples of useful clipping operations are depicted in FIGS. 5 and 6. In particular the clipping depicted in FIG. 5 sets the alpha channel value lower than αₜᵣₐₙₛₚₐᵣₑₙₜ to αₜᵣₐₙₛₚₐᵣₑₙₜ and the values greater than α_{opaque} to α_{opaque}. Conversely the clipping depicted in FIG. 6 sets the alpha channel value to either αₜᵣₐₙₛₚₐᵣₑₙₜ or α_{opaque} depending on whether they are less than αₜᵣₐₙₛₚₐᵣₑₙₜ or greater than α_{opaque}, respectively. The quantity alpha_clipping_type assumes three values: 0, 1, or 2. The value zero corresponds to signal that no clipping will be applied to the alpha channel value. The value 1 corresponds to signal that the clipping depicted in FIG. 5 will be applied to the values while the value 2 corresponds to signal that the clipping in FIG. 6 will be applied. Finally, the quantity alpha_clipping_binary specifies the binary threshold for a clipping operation as the one described in FIG. 6.

FIG. 4 depicts one broadcasting application which requires an alpha channel which has only one frame and then it is repeated for all video frames. In this case the arrangement described in the previous section is only needed for the first frame and then the repetition of the first alpha channel frame can be signalled. The reuse of the alpha channel can signalled in the syntax structures of the coded video which carry the information for the picture level parameters. In one example, the reuse of the alpha channel can be signalled in the Picture Parameter Set (PPS) syntax element of the H.264/AVC and HEVC standards as follows:

...
picture_parameter_set {

...
secondary_picture_status
...

}
...

The flag secondary_picture_status has four values with the following meaning:
0=Secondary picture not present and alpha channel reused from previously decoded frames.
1=Secondary picture present and compressed according to the arrangement specified in the previous section.
2=Secondary picture not present and substituted with a picture with all pixels equal to the transparent value.
3=Secondary picture not present and substituted with a picture with all pixels equal to the opaque value.

The chroma keying technique consists in extracting the pixels from one picture which are different from one specific value (usually referred as the key) of luminance or any other suitable colour space representation (e.g. red, green and blue). Usually given the camera noise and other imperfections during the content acquisition process, the image pixels, although they should have the key value, they present a value slightly different from the key which may be misinterpreted by the chroma key technique. In order to overcome this drawback, some robust chroma keying methods have been devised in the literature which require a significant amount of computational resources. These kinds of chroma keying techniques, may not be suitable when the processing has to be performed at the decoder side. Therefore, one alternative approach is to perform the keying at the transmitter side where the computational resources are less limited and then set the pixels which are meant to have the key value to exactly this key value. The key is then transmitted together with the video and then at the receiver the chroma keying process is a simple binary classification (background/foreground). Since lossy encoding may be applied to the transmitted image, the pixels with the key value may have a value which differs from the original key. In this case an interval value can sent so that all the pixel value falling in that interval can be still considered as belonging to the background. In one example, this interval value may be represented by a tolerance value so that a pixel still belongs to the background if D=|V−K|<T, where V is the pixel value, K is the value for the key, T is the tolerance and denotes the absolute difference. The value for the key and the interval can be transmitted in the syntax structures of the coded video which carry the information for the sequence level parameters. In one example the syntax structure can be the SPS of the H.264/AVC and HEVC standards as follows:

seq_parameter_set( ) {

key_value_present
if( key_value_present ) {

key_value_component_1
...
key_value_component_n
interval_value_component_1
...
interval_value_component_n

}

}

The flag key_value_present indicates whether the coded video contains pixels with a conventions key value. The quantities key_value_component_1, . . . , key_value_component_n specify the key values for each component of the pixels in the video sequence. Finally, the quantities tolerance_value_component_1, . . . , tolerance_value_component_n specify how much a pixel value may differ from the key to be still considered as belonging to the background.

FIG. 2 depicts an example of frame composition with two pictures from frame 0 and frame 1 and an alpha channel. It is useful to compose the frame, transmit some information as an example the final aspect ratio for the pixels of frame 0 and 1. It should be noted that this information may vary along the whole broadcasted program. A useful facility to convey the frame composition information is represented by the Supplementary Enhanced Information (SEI) message. SEI messages are syntax elements specified in both the H.264/AVC and HEVC standards to carry some information useful for display purposes. SEI messages can be transmitted asynchronously from the coded frame and the information specified in one SEI message can be overwritten by another message following the former in the time line. For the problem of frame composition schematically represented in FIG. 2, a possible SEI message arrangement is as follows:

frame_composition_SEI_message {

frame_comp_info_persistence_flag
composite_frame_background_colour_1
...
composite_frame_background_colour_n
frame_0_offset_left
frame_0_offset_top
frame_1_offset_left
frame_1_offset_top
frame_0_width
frame_0_height
frame_1_width
frame_1_height

}

The flag frame_comp_info_persistence_flag specifies whether the current SEI message overwrites the information for frame composition previously received. Depending on the value, the flag may indicate that the information is overwritten only for the frame at the same time instant when the SEI message is received or is overwritten for all the following frames starting from the time instant when the SEI message is received until a new SEI massage is received. The quantities composite_frame_background_colour_1, . . . , composite_frame_background_colour_n specify the colour assumed by all the components of the background pixels in the composite frame. The quantities frame_0_offset_left and frame_0_offset_top specify the position in the composite frame of the top left corner for frame 0. Similarly, the quantities frame_1_offset_left and frame_1_offset_top specifies the position in the composite frame for frame 1. The quantities frame_0_width and frame_0_height specify the width and height of frame 0 in the composite frame. Similar meaning is expressed by frame_1_width and frame_1_height for frame 1.

1. A method of transmitting a composite image comprising at least a foreground image and a transparency mask, the method comprising the steps of:
encoding the foreground image in an encoder;
encoding the transparency mask as an image in the encoder; and
transmitting the encoded foreground image and the encoded transparency mask together with a flag signifying whether or not the encoded transparency mask is to be decoded as a binary transparency mask in which each pixel can take only two values.

2. A method according to claim 1, comprising the step of comparing pixel values in a transparency mask with a threshold to derive a binary transparency mask.

3. A method according to claim 1, further comprising the step of signalling clipping values to a decoder for use in clipping of a decoded binary transparency mask.

4. A method according to claim 1 in which a binary transparency mask is encoded by partitioning each mask into a non-overlapping grid of blocks; coding each block by transmitting its pixel value if all the pixels of the block share the same value or a split flag to signal that the block should be further split; and continuing the process recursively.

5. A method according to claim 4 in which a minimum allowed block size is determined and the process of block splitting continues recursively until the minimum allowed block size is reached.

6. A method according to claim 5 in which the blocks with the minimum size which contain pixels with values which are not all equal are encoded using predictive and entropy coding techniques.

7. A method according to claim 6 in the predictive coding is the Differential Pulse Code Modulation (DPMC).

8. A method according to claim 1, further comprising the steps of:
determining whether the transparency mask is the same as a transparency mask of a preceding image in the video sequence;
encoding the transparency mask as an image only when the transparency mask is not the same as a transparency mask of a preceding image; and
transmitting any encoded transparency mask together with a flag signifying whether the encoded transparency mask for a preceding image is to be used in association with the encoded foreground image of the current image.

9. A method according to claim 1, further comprising the step of transmitting the encoded foreground image together with compositing information such as selected from the group consisting of the size of the foreground image; the location of the foreground image in the composite image and the colour of pixels forming a frame of the composite image.

10. (canceled)

11. (canceled)

12. A method of decoding a composite image, the method comprising the steps of:
receiving an encoded foreground image and an encoded transparency mask together with a flag;
decoding the encoded foreground image in a decoder;
where indicated by the flag, decoding the encoded transparency mask as a binary transparency mask in which each pixel can take only two values; and
using the foreground image in association with the binary transparency mask in forming a composite image.

13. A method according to claim 12, in which an encoded binary transparency mask is partitioned into blocks; the received value is read for each block and if it is equal to either of said two allowed values, then the pixels for a current block are set to the received value; otherwise, the current block is split into blocks with reduced size and the process repeated recursively.

14. A method according to claim 13, when the split process leads to blocks with size equal to the minimum allowed value, then the value of the pixel is set to a value obtained by adding a received difference δ and the value of the previously decoded pixel.

15. A method according to claim 12, wherein the step of decoding the encoded transparency mask as a binary transparency mask, comprises:
a decoding step to produce a preliminary transparency mask in which pixels are not constrained to take only two values; and
a clipping step to produce a binary transparency mask in which pixels are constrained to take only two values.

16. A method according to claim 15, wherein the clipping step utilises clipping values signalled to the decoder by an encoder.

17. A method according to claim 12, further comprising the step of receiving the flag; and where indicated by the flag, using the foreground image in association with the transparency mask for a preceding image in forming a composite image.

18. A method according to claim 12, further comprising the step of receiving an encoded foreground image together with compositing information; and a further step using the foreground image in accordance with the compositing information to form a composite image; said further step being selected from the group consisting of: the foreground image is scaled according to size information in the compositing information; the foreground image is positioned in the composite image according to position information in the compositing information and a frame of the composite image assumes a colour specified by the compositing information.

19. (canceled)

20. (canceled)

21. (canceled)

22. (canceled)

23. A method according to claim 12, in which the composite image forms part of a video sequence of images and in which coded data relating to the transparency mask is transmitted as a secondary picture in the same access unit as the coded data relating to the foreground image forming the primary coded picture.

24. (canceled)

25. A method according to claim 23 in which the flag is represented in the syntax header element Sequence Parameter Set (SPS) of the H.264/AVC or HEVC standard.

26. A method according to claim 23 in which any compositing information is organised in a Supplementary Enhanced Information (SEI) message as specified by the H.264/AVC and the HEVC standards.

27. (canceled)

28. A system for use in the transmitting and receiving of a video sequence including at least one composite image comprising at least a foreground image and a transparency mask, the system comprising:
a video encoder for encoding the foreground image; encoding the transparency mask as an image; and transmitting the encoded foreground image and the encoded transparency mask together with a flag signifying whether or not the encoded transparency mask is to be decoded as a binary transparency mask in which each pixel can take only two values; and
a video decoder for receiving the encoded foreground image and the encoded transparency mask together with the flag; decoding the encoded foreground image; where indicated by the flag, decoding the encoded transparency mask as a binary transparency mask in which each pixel can take only two values; and using the foreground image in association with the binary transparency mask in forming a composite image.

29. (canceled)
